(19) United States
(12) Patent Application Publication
(10) Pub. No.: US 2002/0035858 A1
(43) Pub. Date: Mar. 28, 2002

(54) Treatment of sludge and animal wastes

(76) Inventor: Chris A. Forsha, Blairsville, PA (US)

Correspondence Address: Glenna Hendricks, Esq., P.O.Box 2509, Fairfax, VA, 22031-2509, US

(21) Appl. No.: 09/833,739

(22) Filed: Apr. 13, 2001

Related U.S. Application Data
(60) Provisional application No. 60/197,772, filed on Apr. 14, 2000.

(51) Int. Cl. C05F 7/00

(52) U.S. Cl. 71/15; 71/21

(57) ABSTRACT

The invention provides an improved, cost-effective means of transforming sludge or other waste from vertebrates into fertilizer comprising the steps of 1) mixing a composition containing calcium oxide (CaO) and magnesium oxide (MgO) with sludge or other waste products from vertebrates, 2) allowing the mixture to reach a temperature of about 70° C., then 3) allowing the mixture to remain at a minimum temperature of about 70° C. for a minimum 30 minutes. At the end of this time, most of the material is sufficiently dewatered and can then be bagged to be sold as an organic fertilizer.

### FIELD OF THE INVENTION

This invention relates to the field of sludge management, providing a cost-effective, time-effective means of converting waste into organic fertilizer.

### BACKGROUND OF THE INVENTION

The use of organic fertilizer from human and animal waste has always presented several difficulties. Because of the possibility of introducing infectious organisms into the environment with eventual transmission to consumers through the food chain, it is essential that any process utilized fully pasteurize the waste materials.

Prior art processes relying on an exothermic reaction required from 30 minutes to several days of treatment. The product obtained from the reaction was usually very damp and required long drying time. Hence, an enormous amount of plant space was required in order to provide sufficient drying time of up to 30 to 40 days.

Several prior art processes rely on lowered pH to treat sewage. For example, U.S. Pat. No. 3,960,718 to Lebo teaches lowering the pH of the sewage or waste to 3.0 or less by injecting a stream of oxygen-containing gas into a pressure chamber containing the waste material, then injecting sulfuric acid into the product with oxygenated waste material. U.S. Pat. No. 4,541,986 teaches lowering pH by use of chlorites, with the treatment taking place at temperatures of 5° to 40° C. and at a pH of 5.0 to 7.0.

Several patents teach the use of materials such as lime and/or kiln dust which contain calcium oxide and calcium carbonate. U.S. Pat. No. 4,781,842 to Nicholson teaches a method that requires that the sludge/CaO-containing mixture be maintained at a pH of at least 12 for a day followed by drying. U.S. Pat. No. 4,902,431 teaches and claims a method using kiln dust and lime. The disclosure states that the kiln dust must contain a total of 35% oxides, which may be supplied in the form of CaO and/or MgO. However, no amount of MgO is required. The process as taught therein requires that the mixture of sludge and CaO/MgO must be held at a pH of at least 12 for at least 7 days, then be dried for at least 30 days. The method of that invention requires that the temperature be raised to 50° C. The method of that invention requires enormous amounts of storage space. No amount of MgO is stimpulated, so long as the combined amount of CaO and MgO is at least 35% of the total mixture. (It has now been seen, when practicing the present process, that CaO alone or with small quantities of MgO usually found in kiln dust will not provide the benefits of the instant invention—rapid rise to temperatures of at least 70° C. within a very short time.)

### SUMMARY OF THE INVENTION

It is the purpose of this invention to provide an improved, cost-effective means of transforming sludge or other waste from vertebrates into fertilizer comprising the steps of 1) mixing a composition containing calcium oxide (CaO) and magnesium oxide (MgO) with sludge or other waste products from vertebrates, 2) allowing the mixture to reach a temperature of about 70° C., then 3) allowing the mixture to remain at a minimum temperature of about 70° C. for a minimum 30 minutes. At the end of this time, most of the material is sufficiently dewatered and can then be bagged to be sold as an organic fertilizer. In view of the studies conducted using the instant invention, it has been discovered that when a sufficient amount of MgO is present in the CaO-containing material in the mixture added to the waste it is possible, in about a minute, to raise the temperature of the mixture containing the sludge to above 70° C.

A second aspect of the invention is a plant design which is particularly useful for practice of the invention.

### BRIEF DESCRIPTION OF THE FIGURES

FIG. 1 is an over-head view of a plant design wherein pasteurization process of the invention can be performed.

FIG. 2 shows a side view of the working portion of the plant of FIG. 1 showing a preferred belt arrangement.

FIG. 3 shows an over-head view of the plant design of the area wherein fertilizer is alkalinized by mixing with co-products.

FIG. 4 shows a side view of the working portion of the plant wherein the fertilizer is alkalinized by mixing with co-products.

FIG. 5 shows an odor control system developed by CFI Consultants.

### DETAILED DESCRIPTION OF THE INVENTION

The efficient and effective disposal of wastes such as sludge by converting the sludge into organic fertilizer is important both industrially and environmentally. The instant invention makes it possible to greatly decrease plant size and time required to turn a given amount of sludge into fertilizer that meets the requirements of the environmental regulations while reducing costs. In a preferred embodiment, the process uses compositions containing calcium oxide (CaO) (or CaO and some calcium carbonates) mixed with magnesium oxide (MgO) wherein the MgO is present in sufficient amounts to quickly raise the temperature of the sludge/oxide mixture to at least 70° C. The process usually requires that at least 10% of the oxide-containing composition be MgO, with about 12 to 35% MgO being a preferred concentration for effective and economically feasible operation. A product sold as MAGNALIME™ obtained from Marathon Ashland Petroleum LLC, of Ashland, Ky., which, as sold, has a MgO content of from 17% to 23%, was used in example 1. The CaO/MgO containing mixture may also contain bulking agents such as calcium sulfate. When the mixture containing CaO/MgO was added to sludge or animal waste in a ratio of 4:1 to 1:1 solid waste to Cao/MgO mixture, an exothermic reaction occurs which raises the temperature to about 70° C. in about 1 minute. Under the conditions used in the examples, a ratio of 2.5:1 to 1.5:1 solid waist to CaO/MgO containing mixture proved quite effective. That temperature is maintained for about 30 minutes. After the heating has occurred, the product is piled in heaps and allowed to dry. The resulting product is usable as an organic fertilizer. Once the temperature of this reaction has reached 70° C., the reaction alone will retain the required temperature for 30 minutes.

The addition of monosodium phosphate to the calcium oxide/magnesium oxide mixture provides a product free from the smell of ammonia. The product sold under the name AMMONIA HOLD™ by Ammonia Hold Corporation of Lanoke, Ark. was used in the examples. The sludge was mixed with the MAGNALIME™ in about 4:1 to 1:1 ratio of (1) solids sludge or other forms of animal waste such as runoff from feed lots to (2) MAGNALIME™. The sludge or runoff used in the process usually contained about 5% to 30% solids. Optimum operation usually occurs when the waste product is about 10% to 20% solid wastes. A sufficient amount of MgO in the CaO-containing mixture is required to raise the temperature to at least 70° C. in a very short time and to provide the very rapid drying of the material. The prior art did not recognize the value of adjusting the amount of MgO in a mixture containing CaO and MgO as a means of providing for rapidly rising high level of heat formation for purposes of developing a cost-effective means for converting of waste to fertilizer which is safe for use on food crops.

### EXAMPLE 1

A mixture using MAGNALIME™, containing magnesium oxides, calcium oxides and calcium sulfate is used in this example. The following shows the reaction:

| Reaction | B.T.U.'s produced |
|---|---|
| Calcium oxide (CaO) → → Ca(OH)₂ | 590/lb. |
| Magnesium oxide (MaO) + H₂0 → → Mg(OH)₂ | 590/lb. |
| Calcium sulfate (CaSO₄) + H₂O → → CaSO₄.2H₂O | 50/lb. |

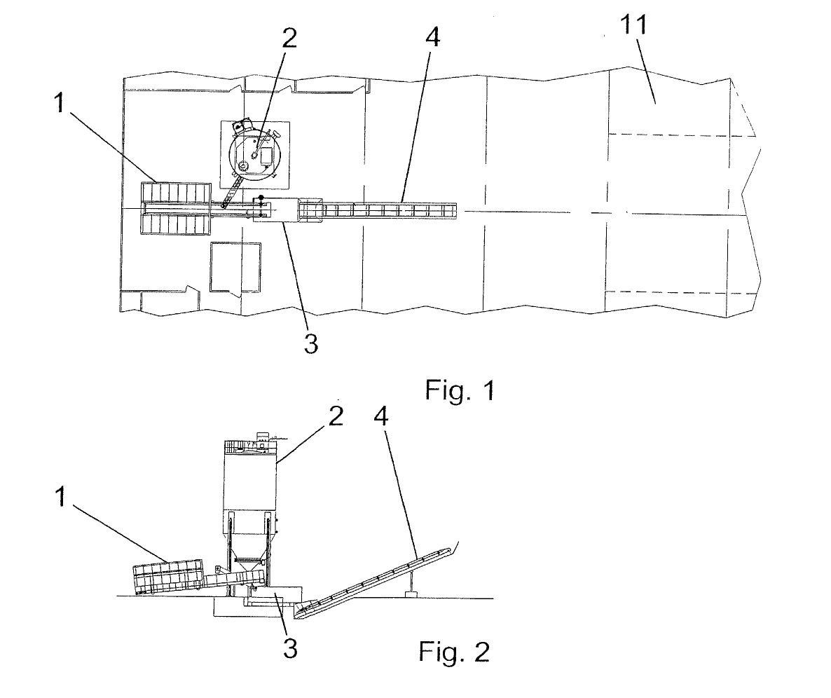

Class 1 or Class 2 municipal waste sludge, ranging from 10% to 20% solids, was placed into the feeder (FIG. 1 (1)). The feeder then transfered the sludge into the auger-type mixer (FIG. 1 (3)). During this process, MAGNALIME™ was combined with the sludge via an auger system (FIG. 1 (B)) at a ratio of about 2 parts sludge solids to 1 part MAGNALIME™. The two materials were then fed into the auger-type mixer (FIG. 1 (3)) where mixing took place for about 1 minute. The mixture reached a temperature of over 70° C. This temperature was maintained for a minimum of 30 minutes as the combined MAGNALIME™/sludge mixture was placed on the stacker belt (FIG. 1 (4)) and discharged onto a pile on the floor of the facility.

Because of the intense heat, the sludge/MAGNALIME™ mixture dried in less than an hour. The resulting product was appropriate for immediate packaging in bags for sale as fertilizer. In order to provide a more alkaline mixture, the product of Example 1 is mixed with co-products such as fly ash or kiln dust, as in example 2, to increase pH of the product.

### EXAMPLE 2

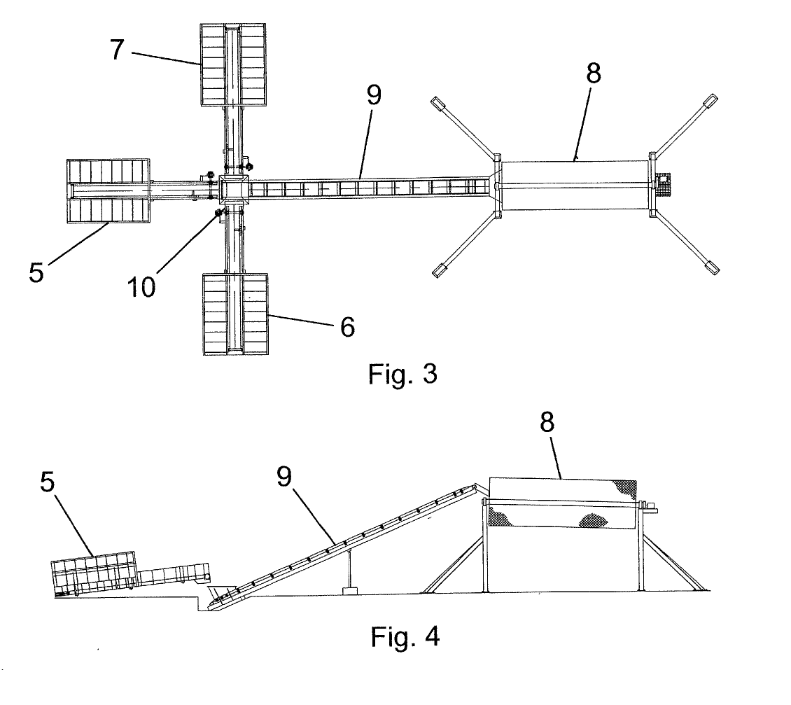

The product from example 1 (the pasteurization process) was deposited in a first feeder (FIG. 3 (5)), peco lime was deposited in a second feeder (FIG. 3 (7)) and kiln dust was deposited in a third feeder (FIG. 3 (6)). All three components were fed onto the stacker belt (FIG. 3 (9)) at a ratio of about 3 parts pasteurized material from Example 1 to 1 part each peco lime and kiln dust. The combined materials are transported to the mixing drum (FIG. 3 (9)) for mixing. The product is then ready to be sacked for transport and sale.

This process adds alkalinity to the mixture and prevents attraction of pests such as insects and rodents. A pH of about 11.5 to 12 was attained in the final mixture.

The plant layout required to practice the process of this invention includes a feeder (FIG. 1 (1)) from which the sludge or other animal waste is fed into a silo (2) where the sludge and the CaO/MgO containing composition is added. The material is then passed to a mixer (3). After mixing has occurred and a temperature of 70° C. has been reached (about 30 seconds to 1 minute is usually sufficient), the resulting mixture was be discharged onto a stacker belt.

It is usually desirable to raise the pH of the organic fertilizer to at least 11.5 in order to prevent infestation with pests such as insects or rodents. As indicted in Example 2, a desirable plant setup is one wherein feeders containing various materials (co-products) such as kiln dust, fly ash and peco lime, can be controllably added to the fertilizer to increase pH. As exemplified in FIG. 3 feeders with additives ((6) and (7)) and the pasteurized fertilizer (5) are attached to belts which deliver the required amount of each product to a common area (10) which then feeds the product from (10) into a mixer (8).

Mixers for use in treating organic waste are known in the art. For example, U.S. Pat. Nos. 4,474,479 and 5,186,840, which are incorporated herein by reference in their entirety, teach mixers for use in conversion of sludge which may be used in practice of this invention.

It is also possible to remove ammonia from the sludge under treatment by exposing the heated waste to an odor control system. Such systems often have scrubbers or spraying systems which collect and treat or transform noxious components to avoid discharge of objectionable gases into the environment. There are several odor control systems available. For example, R J Environmental, Inc. of San Diego, Calif., sells a system known as the LO/PRO™ Odor Control System.

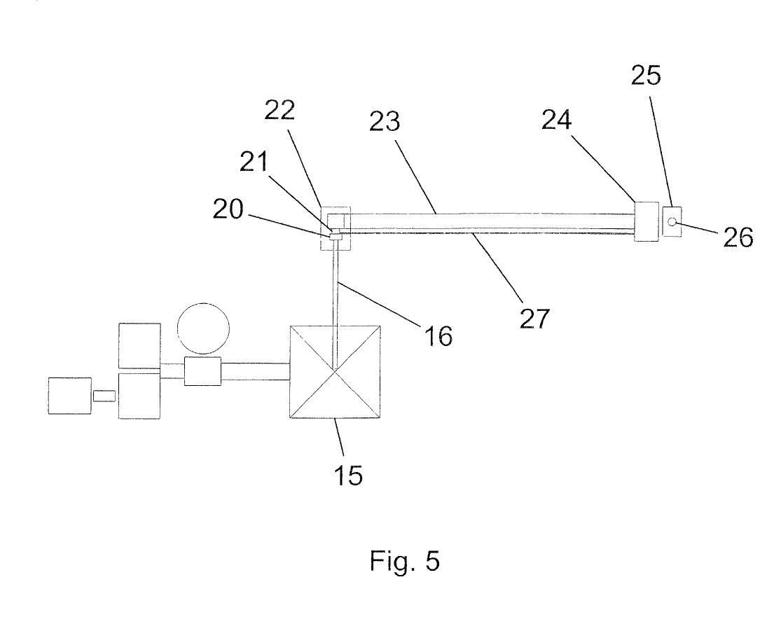

A new odor control system has been developed by CFI Consultants of Blairsville, Pa. This system is shown in FIG. 5, wherein the heated mixture of waste and CaO/MgO passes under a hood or through a retention chamber (FIG. 5(15)), The gases then pass though duct work (16), thence through a blower (20) wherein a spray of water controlled by a spray ring (21) is added. The moistened vapor passes through a piping (23) to a pump house, where it is then pumped on to a sump (25) and then through a discharge unit (26). Some of the water is returned through piping (27) into the spray unit.

The inventive process described herein is very cost effective, making it possible to provide efficient transformation of waste into fertilizer that is safe for use in agriculture and landscaping endeavors. The process decreases the amount of space required for processing and holding the mixtures containing calcium oxides and waste at high pH for many many days before preparing for sale and shipment.

What we claim is:

1. A process for transforming sludge and other waste products from vertebrates into fertilizer comprising the steps of:
1) mixing (i) a composition containing CaO and MgO wherein the MgO is present in the CaO/MgO mixture to a concentration of at least 10% MgO, with (ii) sludge or waste products from vertebrates,
2) allowing the mixture produced in step 1 to reach a minimum temperature of 70° C.,
3) allowing the product of step 2 to remain at a temperature of at least 70° C. for 30 minutes to one hour.

2. The process of claim 1 wherein the composition containing CaO and MgO is MAGNALIME™.

3. The process of claim 1 wherein the waste product is sludge.

4. The process of claim 1 wherein the ratio of solid waste to CaO/MgO composition is about 2:1.

5. The process of claim 1 wherein the composition containing CaO and MgO contains 12% to 35% MgO.

6. The process of claim 1 wherein, during and/or after step 3, the mixture is passed under a hood or through a chamber that leads to a system which deodorizes the gases.

7. A method of claim 1 wherein the composition containing CaO and MgO also contains calcium carbonates.
